(19) United States
(12) Patent Application Publication
(10) Pub. No.: US 2006/0078279 A1
(43) Pub. Date: Apr. 13, 2006

(54) Broadcasting content processing apparatus and method of controlling the same

(75) Inventor: Naozumi Koshino, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/231,785

(22) Filed: Sep. 22, 2005

(30) Foreign Application Priority Data
Sep. 27, 2004 (JP) 2004-280696

(51) Int. Cl. H04N 5/76

(52) U.S. Cl. 386/46; 386/125

(57) ABSTRACT

A broadcasting contents processing apparatus includes a setting device to set position information in the apparatus, the position information indicating an area where the apparatus is installed, an acquiring device to selectively acquire first identification information indicating a broadcaster of a broadcasting content of a desired channel among broadcasting contents of the channels, and second identification information indicating information of the broadcasting content, and a controller which manages the broadcasting contents of each channel on the recording medium in association with the first identification information and the second identification information, reads from the recording medium corresponding broadcasting contents on the basis of a requested channel, the set position information and the first and the second information.

### CROSS-REFERENCE TO RELATED APPLICATIONS

This application is based upon and claims the benefit of priority from prior Japanese Patent Application No. 2004-280696, filed Sep. 27, 2004, the entire contents of which are incorporated herein by reference.

### BACKGROUND OF THE INVENTION

1. Field of the Invention

This invention relates to a broadcasting content processing apparatus, such as home television sets and video tape recorders, which receives broadcasting contents broadcasted through a broadcasting network to which different channels are assigned according to its broadcasting service areas and records the contents if necessary, and a method of controlling the same.

2. Description of the Related Art

As is generally known, digitalization of television broadcasting has recently been promoted. For example, in Japan, terrestrial digital broadcasting has been started, as well as satellite digital broadcasting such as BS (Broadcasting Satellite) digital broadcasting and CS (Communication Satellite) 110° digital broadcasting.

Digital broadcasting receivers which receive such digital television broadcasting can record received programs in digital form, and reproduce the recorded programs, by connecting digital recording apparatuses of a large capacity such as HDD (Hard Disk Drive) thereto.

Further, currently, a plurality of digital recording apparatuses are connected to one digital broadcasting receiver to form a network, and thereby the digital broadcasting receiver can designate any one of the digital recording apparatuses to have it record a program, and designate any one of the digital recording apparatuses to have it reproduce a recorded program. Further, there have been proposed a digital broadcasting receiver having an Internet receiving function (for example, Jpn. Pat. Appln. KOKAI Pub. No. 10-136275).

In the meantime, different channel numbers are assigned to a broadcasting station in the broadcasting system according to the areas. Therefore, in the digital broadcasting receiver, if a recorded content broadcasted by a specific broadcasting station is searched for simply on the basis of the channel number, recorded contents broadcasted by a different broadcasting station in the previous residential area are displayed in list form as the search result. Displaying also recorded contents of the different broadcasting station makes the display screen unnecessarily complicated for the user. Therefore, there is a users' strong demand for displaying a list including only broadcasting contents searched on the basis of the current residential area.

### BRIEF SUMMARY OF THE INVENTION

The object of the present invention is to provide a broadcasting content processing apparatus and a broadcasting content processing method, which can extract and display a suitable broadcasting content from a plurality of recorded broadcasting contents according to the area.

According to an aspect of the present invention, there is provided a broadcasting content processing apparatus receiving broadcasting contents transmitted by a broadcasting network to which channels are assigned according to broadcasting service areas, and recording broadcasting contents of any channels on a recording medium in accordance with a recording instruction input, comprising: a setting device to set position information in the apparatus, the position information indicating an area where the apparatus is installed; an acquiring device to selectively acquire first identification information indicating a broadcaster of a broadcasting content of a desired channel among broadcasting contents of the channels, and second identification information indicating information of the broadcasting content; and a controller which manages the broadcasting contents of each channel on the recording medium in association with the first identification information and the second identification information, reads from the recording medium corresponding broadcasting contents based on a requested channel, the set position information and the first and the second information.

According to another aspect of the present invention, there is provided a method of controlling a broadcasting content processing apparatus receiving broadcasting contents transmitted by a broadcasting network to which channels are assigned according to broadcasting service areas, and recording broadcasting contents of any channels on a recording medium in accordance with a recording instruction input, comprising: setting position information in the broadcasting content processing apparatus, the position information indicating an area where the broadcasting content processing apparatus is installed; selectively acquiring first identification information indicating a broadcaster of a broadcasting content of a desired channel among broadcasting contents of the channels, and second identification information indicating information of the broadcasting content; and managing the broadcasting contents of each channel on the recording medium in association with the first identification information and the second identification information, reading from the recording medium corresponding broadcasting contents on the basis of a requested channel, the set position information and the first and the second information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram for schematically explaining a digital television broadcasting receiver according to a first embodiment of the present invention and an example of a network system including the receiver as main part.

FIG. 2 is a block diagram illustrating a main signal processing system of the digital television broadcasting receiver in the first embodiment.

FIG. 3 is a flowchart illustrating operation by which the digital television broadcasting receiver records a program in a digital recording apparatus in the first embodiment.

FIG. 4 is a flowchart illustrating operation by which the digital television broadcasting receiver reproduces a program from a digital recording apparatus in the first embodiment.

FIG. 5 is a diagram illustrating an example of a keyword search screen of the digital television broadcasting receiver in the first embodiment.

FIG. 6 is a diagram illustrating an example of an image displaying a list of programs obtained by keyword search among programs recorded in a specific apparatus connected to the digital television broadcasting receiver in the first embodiment.

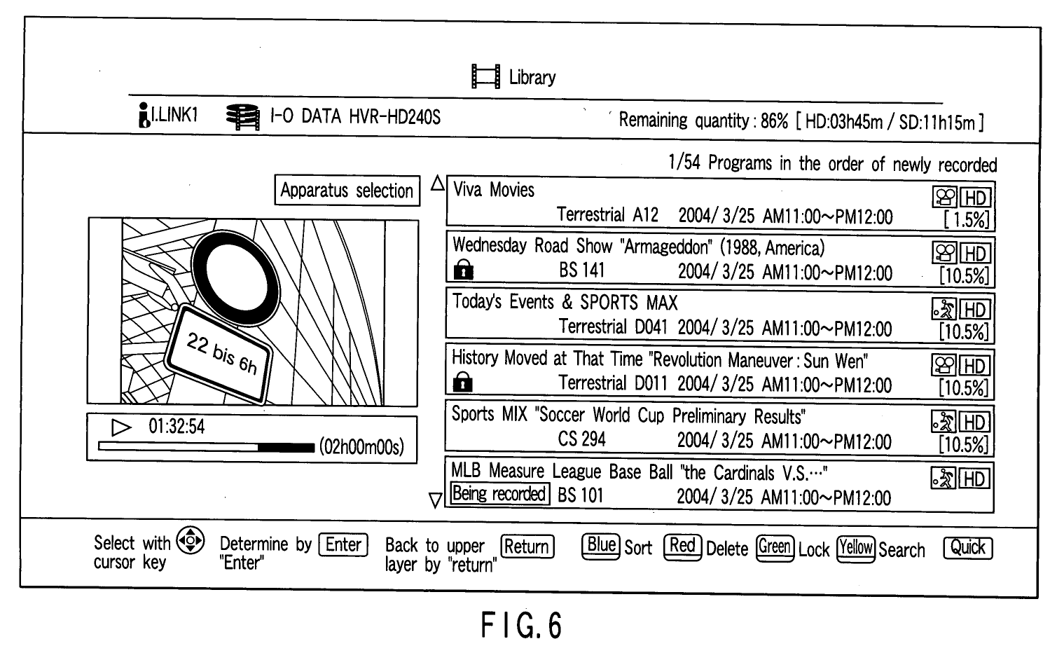

FIG. 7 is a block diagram illustrating a main signal processing system of a digital television broadcasting receiver according to a second embodiment of the present invention.

### DETAILED DESCRIPTION OF THE INVENTION

Embodiments of the present invention will be described in detail below with reference to drawings.

### FIRST EMBODIMENT

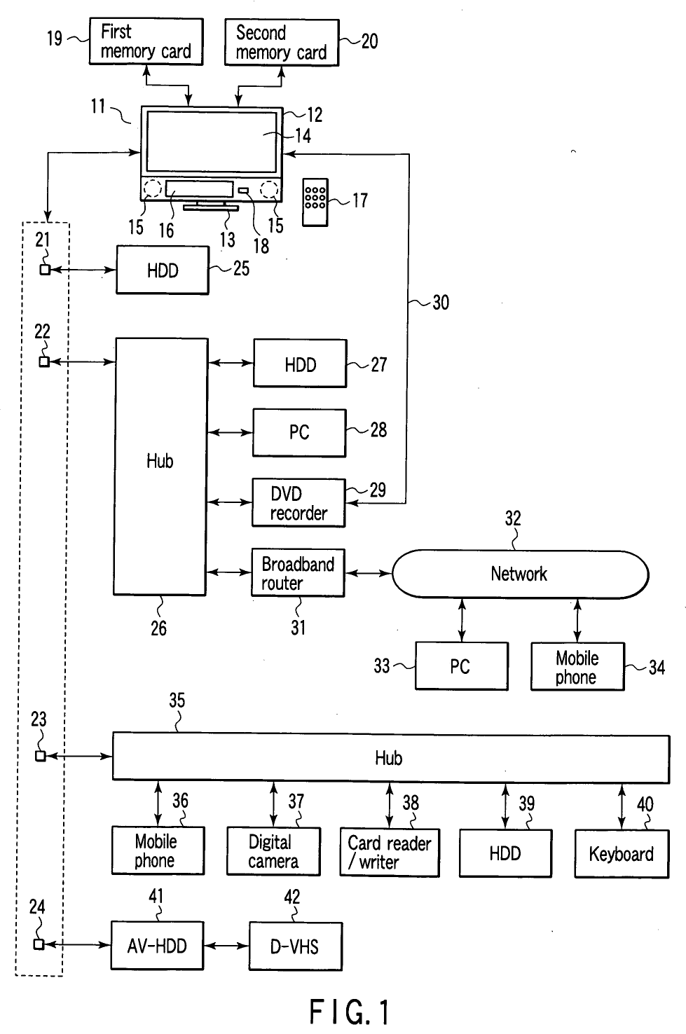

FIG. 1 schematically illustrates an appearance of a digital television broadcasting receiver 11 to be explained as a first embodiment of the present invention, and an example of a network system including the digital television broadcasting receiver 11 as main part.

Specifically, the digital television broadcasting receiver 11 mainly comprises a thin cabinet 12, and a support stand 13 which supports the cabinet 12 in a standing state. Further, the cabinet 12 is provided with a flat-panel image display 14 formed of a liquid crystal display panel and the like, a speaker 15, an operating section 16, and a light-receiving section 18 which receives operation information transmitted from a remote controller 17.

A first memory card 19, such as an SD (Secure Digital) memory card, an MMC (Multimedia Card) and a memory stick, is removably inserted into the digital television broadcasting receiver 11. Information such as programs and photographs are recorded on and reproduced from the first memory card 19.

Further, a second memory card (IC card) 20 recording contract information and the like is removably inserted into the digital television broadcasting receiver 11. Information is recorded on and reproduced from the second memory card 20.

The digital television broadcasting receiver 11 also comprises a first LAN (Local Area Network) terminal 21, a second LAN terminal 22, a USB (Universal Serial Bus) terminal 23 and an i. Link terminal 24.

Among the terminals, the first LAN terminal 21 is used as a port dedicated to a LAN-ready HDD. The first LAN terminal 21 is used to record and reproduce information on and from a LAN-ready HDD 25, which is a NAS (Network Attached Storage) connected to the LAN terminal 21, by Ethernet (registered trademark).

As described above, providing the first LAN terminal 21 as a port dedicated to a LAN-ready HDD enables stable information recording of programs with a high-definition television image quality on the HDD 25.

The second LAN terminal 22 is used as a general LAN-ready port using the Ethernet. For example, the second LAN terminal 22 is connected to apparatuses such as a LAN-ready HDD 27, a PC (Personal Computer) 28, an HDD-included DVD (Digital Versatile Disk) recorder 29 through a hub 26, and is used to perform information transmission with these apparatuses.

With respect to the DVD recorder 29, the digital information of the DVD recorder 29 transmitted through the second LAN terminal 22 is only controlling information. Therefore, it is necessary to provide a dedicated analogue transmission line 30, to transmit analogue image and sound information between the DVD recorder 29 and the digital television broadcasting receiver 11.

Further, the second LAN terminal 22 is connected to a network 32 such as the Internet through a broadband router 31 connected to the hub 26, and is used to perform information transmission with a PC 33 and a cellular phone 34 and the like through the network 32.

The USB terminal 23 is used as a general USB-ready port. For example, the USB terminal 23 is connected to USB apparatuses such as a cellular phone 36, a digital camera 37, a card reader/writer 38 for a memory card, an HDD 39, and a keyboard 40, through a hub 35, and is used to perform information transmission with these USB apparatuses.

The i. Link terminal 24 is connected to an AV-HDD 41 and a D (Digital)-VHS (Video Home System) 42 in series, and is used to perform information transmission with these apparatuses.

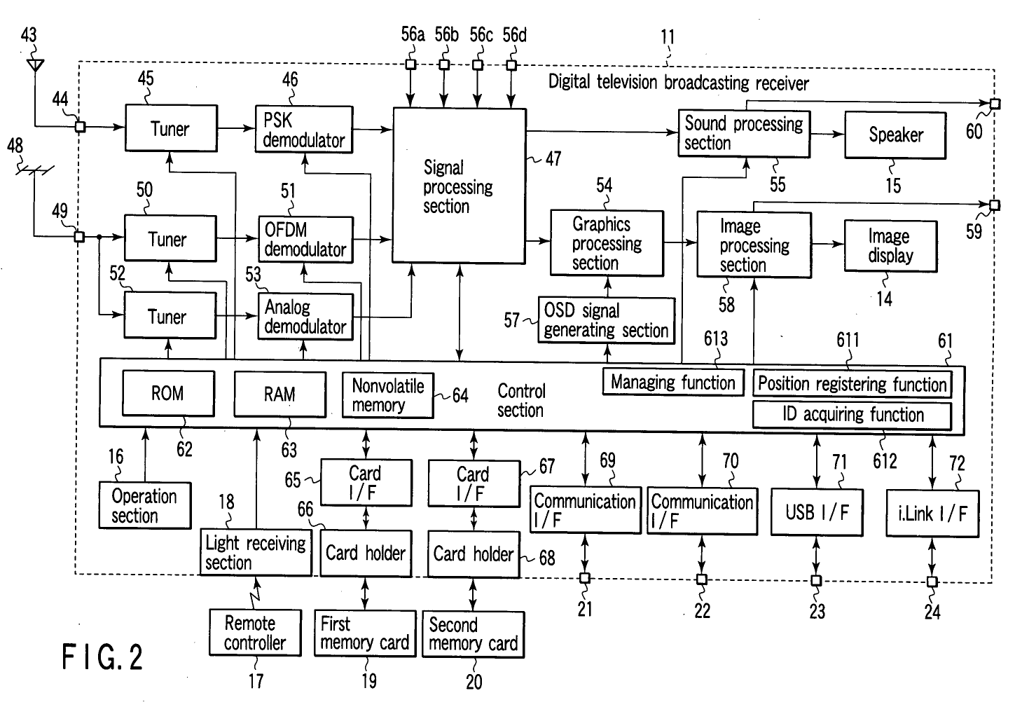

FIG. 2 illustrates a main signal processing system of the digital television broadcasting receiver 11. Specifically, satellite digital television broadcasting signals received by an antenna 43 for receiving BS/CS digital broadcasting are supplied to a satellite digital broadcasting tuner 45 through an input terminal 44, and thereby a broadcasting signal of a desired channel is selected from the signals.

The broadcasting signal selected by the tuner 45 is supplied to a PSK (Phase Shift Keying) demodulator 46, demodulated to a digital image signal and a digital sound signal, and thereafter outputted to a signal processing section 47.

Terrestrial digital television broadcasting signals received by an antenna 48 for receiving terrestrial broadcasting are supplied to a terrestrial digital broadcasting tuner 50 through an input terminal 49, and thereby a broadcasting signal of a desired channel is selected from the signals.

The broadcasting signal selected by the tuner 50 is supplied to an OFDM (Orthogonal Frequency Division Multiplexing) demodulator 51, demodulated to a digital image signal and a digital sound signal, and outputted to the signal processing section 47.

Terrestrial analogue television broadcasting signals received by the antenna 48 for receiving terrestrial broadcasting are supplied to a terrestrial analogue broadcasting tuner 52 through the input terminal 49, and thereby a broadcasting signal of a desired channel is selected from the signals. The broadcasting signal selected by the tuner 52 is supplied to an analogue demodulator 53, demodulated to an analogue image signal and an analogue sound signal, and outputted to the signal processing section 47.

The signal processing section 47 selectively performs a predetermined digital signal processing to the digital image signals and the digital sound signals provided from the PSK demodulator 46 and the OFDM demodulator 51, and outputs them to a graphic processing section 54 and a sound processing section 55.

A plurality of (4 in the illustrated example) input terminals 56a, 56b, 56c and 56d are connected to the signal processing section 47. Each of the input terminals 56a to 56d enables input of analogue image signals and analogue sound signals from the outside of the digital television broadcasting receiver 11.

The signal processing section 47 selectively digitizes analogue image signals and analogue sound signals supplied from the analogue demodulator 53 and the input terminals 56a to 56d, performs a predetermined digital signal processing to the digitized image signals and sound signals, and outputs them to the graphic processing section 54 and the sound processing section 55.

Among them, the graphic processing section 54 has a function of superposing an OSD (On Screen Display) signal generated by an OSD signal generating section 57 on the digital image signal supplied from the signal processing section 47, and outputting the superposed signal. The graphic processing section 54 can selectively output the output image signal of the signal processing section 47 and the output OSD signal of the OSD signal generating section 57. Further, the graphic processing section 54 can output both the signals in combination such that each of them form a half of the screen.

The digital image signal outputted from the graphic processing section 54 is supplied to an image processing section 58. The image processing section 58 converts the input digital image signal into an analogue image signal in a format which enables display thereof on the image display 14. Then, the image processing section 58 outputs the converted signal to the image display 14 to display it as an image, and guides it to the outside through an output terminal 59.

The sound processing section 55 converts the input digital sound signal into an analogue sound signal in a format which enables reproduction thereof by the speaker 15. Then, the sound processing section 55 outputs the converted signal to the speaker 15 to reproduce it as sound, and guides it to the outside through an output terminal 60.

A control section 61 controls all the operations of the digital television broadcasting receiver 11, including the above receiving operations. The control section 61 includes a CPU (Central Processing Unit) and the like. The control section 61 receives operation information from the operating section 16, or receives operation information transmitted from the remote controller 17 through the light-receiving section 18, and controls the sections of the receiver 11 to reflect the operation indicated by the operation information.

In this example, the control section 61 mainly comprises a ROM (Read Only Memory) 62 storing a control program to be executed by the CPU, a RAM (Random Access Memory) 63 which provides a work area to the CPU, and a nonvolatile memory 64 storing various setting information and control information and the like.

The control section 61 is connected to a card holder 66, into which the first memory card 19 is can be fitted, with a card I/F (Interface) 65 interposed therebetween. Thereby, the control section 61 can perform information transmission with the first memory card 19 fitted into the card holder 66 through the card I/F 65.

Further, the control section 61 is connected to a card holder 68, into which the second memory card 20 can be fitted, with a card I/F 67 interposed therebetween. Thereby, the control section 61 can perform information transmission with the second memory card 20 fitted into the card holder 68 through the card I/F 67.

The control section 61 is also connected to the first LAN terminal 21 through a communication I/F 69. Thereby, the control section 61 can perform information transmission with the LAN-ready HDD 25 connected to the first LAN terminal 21, through the communication I/F 69. In this case, the control section 61 has a DHCP (Dynamic Host Configuration Protocol) server function, and performs control by assigning an IP (Internet Protocol) address to the LAN-ready HDD 25 connected to the first LAN terminal 21.

The control section 61 is also connected to the second LAN terminal 22 through a communication I/F 70. Thereby, the control section 61 can perform information transmission with the apparatuses (see FIG. 1) connected to the second LAN terminal 22 through the communication I/F 70.

The control section 61 is also connected to the USB terminal 23 through a USB I/F 71. Thereby, the control section 61 can perform information transmission with the apparatuses (see FIG. 1) connected to the USB terminal 23 through the USB I/F 71.

The control section 61 is also connected to the i. Link terminal 24 through an i. Link I/F 72. Thereby, the control section 61 can perform information transmission with the apparatuses (see FIG. 1) connected to the i. Link terminal 24 through the i. Link I/F 72.

In the meantime, according to the first embodiment, the control section 61 is provided with a position registering function 611, an ID acquiring function 612, and a managing function 613, as functions related to the present invention. The position registering function 611 displays a position registering image on the image display 14 by input operation by the user, at the time of purchasing the apparatus and reinstalling the apparatus by house-moving, etc., and registers area information corresponding to a postal code or the like input by the operating section 16 or the remote controller 17 in the RAM 63.

When a broadcasting content including digital image signals is recorded, the ID acquiring function 612 extracts a network ID and a service ID contained in the broadcasting content. The network ID is identification information indicating a broadcaster of the broadcasting content, and the service ID is identification information indicating a genre and the like of the broadcasting content. These IDs are added to the broadcasting content as non-compressed metadata.

The managing function 613 manages the broadcasting contents of each channel recorded on the HDD 25 in association with their network IDs and service IDs. The managing function 613 reads a plurality of broadcasting contents corresponding to a desired channel from the HDD 25, on the basis of the desired channel, the set area information, the network ID and the service ID, and displays the contents in list form on the image display 14.

Next, processing operation in the above structure is explained.

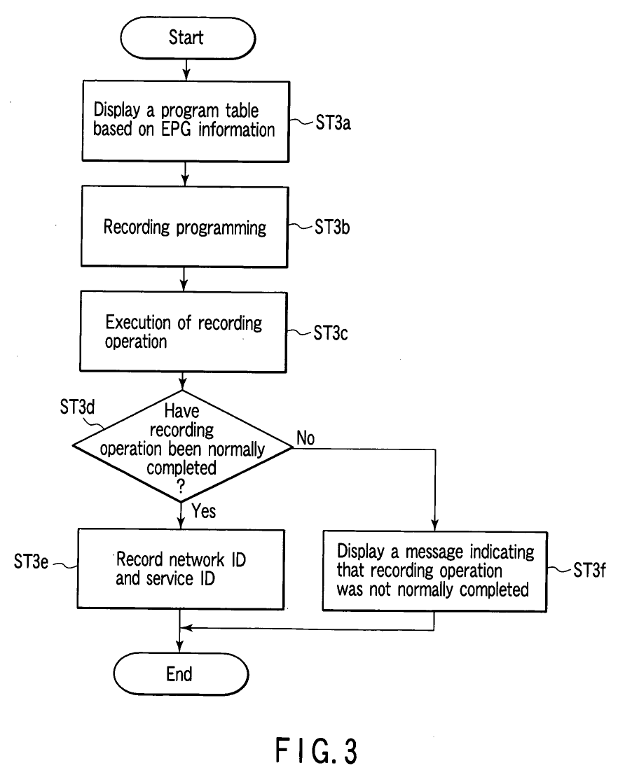

FIG. 3 is a flowchart illustrating operation of recording a broadcasting content by the digital television broadcasting receiver 11. In this explanation, a broadcasting content is referred to as “program”.

Specifically, when processing is started by a request to record a program, the control section 61 displays a program table on the image display 14, on the basis of an EPG (Electronic Program Guide) information obtained from a broadcasting signal (step ST3a).

Then, when the user programs the apparatus to record a desired program based on the displayed program table, the control section 61 proceeds to recording programming process (step ST3b).

Next, when a pre-selected time for recording has come, the control section 61 executes recording operation to record the pre-selected program on the programmed HDD 25 (step ST3c). Thereafter, the control section 61 determines whether the program recording operation has been normally completed (step ST3c). If it is determined that the program recording operation has been normally completed (YES), the control section 61 records a network ID and a service ID corresponding to the recorded program on the HDD 25 (step ST3e).

Further, if it is determined that the program recording operation was not normally completed (NO), the control section 61 displays a message indicating that the program recording operation was not normally completed on the image display 14 (step ST3f), and ends the processing.

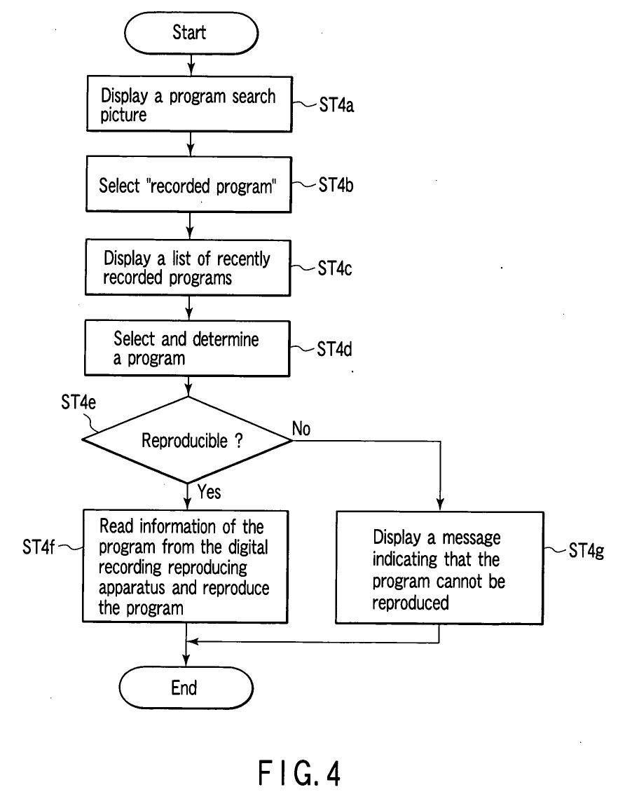

FIG. 4 is a flowchart illustrating operation of promptly retrieving a desired program from various programs recorded on the HDD 25, and reproducing the program.

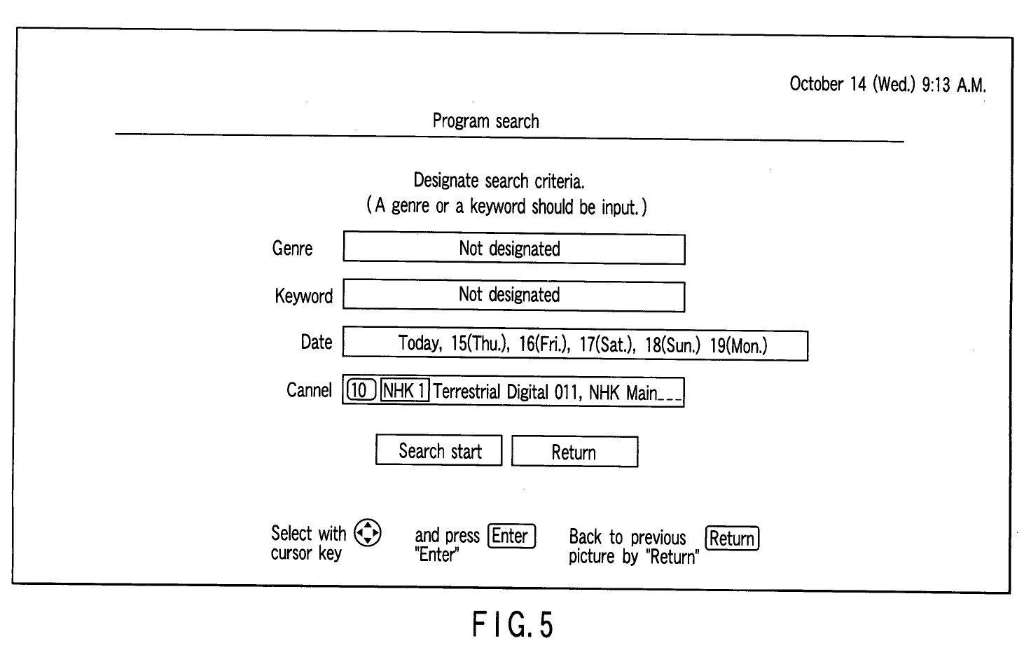

Specifically, when the process is started, the control section 61 displays a keyword search image as shown in FIG. 5 on the image display 14, in response to operation of the remote controller 17 (step ST4a). In the keyword search image, four items including “genre”, “keyword”, “date”, “channel” are input. Then, when a “Recorded Program” key of the remote controller 17 is pressed (step ST4b), the control section 61 detects programs corresponding to the search conditions based on the network IDs and the service IDs recorded on the selected HDD 25, and displays a list of the detected programs on the image display 14 (step ST4c).

Thereafter, when the user selects a desired program by operating cursor keys of the remote controller 17 and presses an “ENTER” key (step ST4d), the control section 61 determines whether the selected program is reproducible or not (step ST4e).

If it is determined that the program is reproducible (YES), the control section 61 reads from the HDD 25 information of the program reproduction of which has been requested, and executes reproduction (step ST4f). In the meantime, if it is determined that the program is not reproducible (NO), the control section 61 displays on the image display 14 a message indicating that the requested program cannot be reproduced, and ends the process (step ST4g).

As described above, according to the first embodiment, the control section 61 manages the broadcasting contents of each channel recorded on the HDD 25 in association with their network IDs and service IDs. Therefore, when a request occurs to selectively display broadcasting contents of a desired channel, the control section 61 selects only suitable broadcasting contents broadcasted in the current resident area and displays a list of the contents on the image display 14, on the basis of the area information registered in the RAM 63 and the network IDs and the service IDs in the HDD 25.

Therefore, it is possible to display more broadcasting contents of a desired channel, broadcasted in the current resident area, as candidates, and exclude broadcasting contents of areas other than the current resident area from selection candidates. This further enhances the efficiency of determination of a desired broadcasting content. This allows the user to select a desired broadcasting content with a less complicated display image.

Further, according to the above first embodiment, a broadcasting content to be recorded is recorded on the designated HDD 25 by using a network ID and a service ID assigned to the broadcasting content, and is automatically managed in association with the network ID and the service ID. This dispenses the user from manual operation to associate each broadcasting content with its network ID and service ID.

### SECOND EMBODIMENT

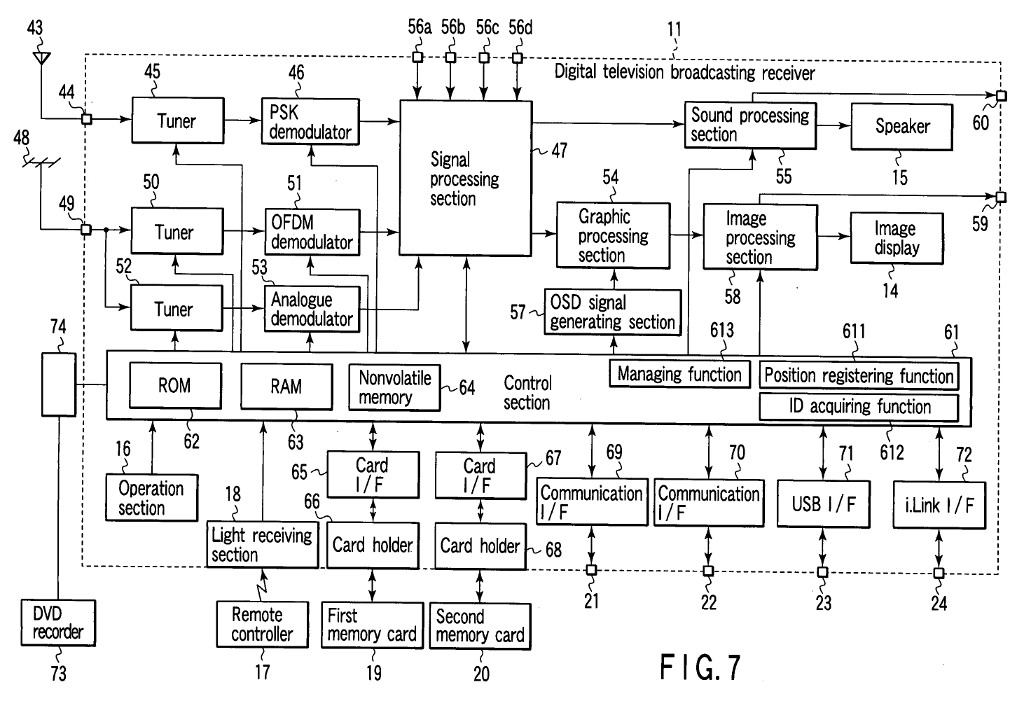

FIG. 7 is a block diagram illustrating functions and configuration of a digital television broadcasting receiver 11 according to a second embodiment of the present invention. In FIG. 7, the same reference numerals are assigned to the same respective members as those in FIG. 2, and their detailed explanations are omitted.

Specifically, a control section 61 is provided with an interface 74 for connecting a DVD recorder 73 which is separately prepared. Further, a managing function 613 of the control section 61 transmits and receives broadcasting contents to be recorded and network IDs and service IDs of the broadcasting content to and from the DVD recorder 73 through the interface 74.

As described above, according to the second embodiment, the DVD recorder 73 collectively records and manages a plurality of broadcasting to be recorded and network IDs and service IDs associated with the broadcasting contents. This saves the storage capacity of the HDD 25. Further, it is also possible to record broadcasting contents important for the user on the DVD recorder 73, and record those not important for the user on the HDD 25.

### OTHER EMBODIMENTS

The present invention is not limited to the above embodiments. For example, in the above embodiments, explained are examples in which broadcasting contents are managed by using network IDs and service IDs contained in the broadcasting contents to be recorded. However, the present invention is not limited to it. If broadcasting contents do not contain network IDs or service IDs, it is possible to obtain network IDs and service IDs from the broadcasters, by accessing the broadcasters through telephone line and the like.

The present invention is not limited to the above embodiments, but can be variously modified in carrying out it without departing from the gist of the invention. Further, various inventions can be made by combining a plurality of constituent elements disclosed in the above embodiments according to necessity. For example, some of the constituent elements disclosed in an embodiment may be deleted. Further, constituent elements of different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcasting content processing apparatus receiving broadcasting contents transmitted by a broadcasting network to which channels are assigned according to broadcasting service areas, and recording broadcasting contents of any channels on a recording medium in accordance with a recording instruction input, comprising:
a setting device to set position information in the apparatus, the position information indicating an area where the apparatus is installed;
an acquiring device to selectively acquire first identification information indicating a broadcaster of a broadcasting content of a desired channel among broadcasting contents of the channels, and second identification information indicating information of the broadcasting content; and
a controller which manages the broadcasting contents of each channel on the recording medium in association with the first identification information and the second identification information, reads from the recording medium corresponding broadcasting contents based on a requested channel, the set position information and the first and the second information.

2. A broadcasting content processing apparatus according to claim 1, wherein
when the first information and the second identification information of the broadcasting content are added to the content itself, the controller manages the broadcasting content on the recording medium, based on the first identification information and the second identification information obtained when the broadcasting content is received.

3. A broadcasting content processing apparatus according to claim 1, further comprising:
an interface to connect to an external apparatus,
wherein the controller performs communication of the broadcasting content and the first identification information and the second identification information of the broadcasting content with the external apparatus through the interface.

4. A method of controlling a broadcasting content processing apparatus receiving broadcasting contents transmitted by a broadcasting network to which channels are assigned according to broadcasting service areas, and recording broadcasting contents of any channels on a recording medium in accordance with a recording instruction input, comprising:
setting position information in the broadcasting content processing apparatus, the position information indicating an area where the broadcasting content processing apparatus is installed;
selectively acquiring first identification information indicating a broadcaster of a broadcasting content of a desired channel among broadcasting contents of the channels, and second identification information indicating information of the broadcasting content; and
managing the broadcasting contents of each channel on the recording medium in association with the first identification information and the second identification information, reading from the recording medium corresponding broadcasting contents on the basis of a requested channel, the set position information and the first and the second information.
